(19) United States
(12) Patent Application Publication
(10) Pub. No.: US 2013/0169074 A1
(43) Pub. Date: Jul. 4, 2013

(54) SYNCHRONOUS RELCUTANCE MOTOR FOR CONDUCTING MEDIA

(71) Applicants: Sheikh Nayyer Hussain, Islamabad (PK); Muhammad Nasir Khan, Islamabad (PK)

(72) Inventors: Sheikh Nayyer Hussain, Islamabad (PK); Muhammad Nasir Khan, Islamabad (PK)

(21) Appl. No.: 13/341,958

(22) Filed: Dec. 31, 2011

(51) Int. Cl. H02K 19/02

(52) U.S. Cl. 310/49.43

(57) ABSTRACT

A synchronous reluctance motor for conveying media with large air gap for low speed operation with simple scalar control, which comprises a stator and a tapered reluctance rotor are reported.

### FIELD OF INVENTION

The instant invention relates to an electric motor.

### BACKGROUND INFORMATION

One of the applications of the electric motors is in their use for conducting media. In these applications the rotor is connected to a media impeller with the help of shaft and by way of this may regulate the flow of media [1]. This requires dedicated magnetic couplings or fluidic seals. Employing large air gap between rotor and stator can eliminate these magnetic couplings or fluidic seals. In this technique, a non-magnetic material is inserted into the air gap to create a pressure, chemical or environmental seal [2].

The survey of the operation of existing motors brings to light that motors with large air gap are very rare. Mainly motors exploiting large air gap are specially designed permanent magnet motors for specific applications, mainly in the chemical industry and medical applications etc. The specific examples of this type of motor include turbo charger, centrifugal blood pumps, growing prosthesis etc. [1-4]. Apart from these specially designed motors, the air gap between rotor and stator is kept as minimum as possible to optimize the motor performance [5-10].

### SUMMARY OF INVENTION

The instant invention relates to a synchronous reluctance motor, which has an extremely simple and rugged construction and an extremely large air gap between rotor and stator for low speed operation. This large air gap can be used as media passage opening and for placing a pressure chemical or environmental seal with regard to the conducting media.

Here, basically all substances capable of flowing are to be understood as “media”, e.g., gases, liquids, pastes, powders or granular substances.

The instant media gap motor is constructed from the stator and rotor of a conventional three phase induction motor, but with the particularity of the shape of the rotor, which makes it a synchronous reluctance motor with an large air gap between rotor and stator.

Different rotor shapes were analyzed in order to form the best rotor shape in terms of stable behavior, least current and maximum torque. The best shape came out to be tapered type. The motor is controlled on the basis of simple scalar V/f control without need for any sensors.

The motor is designed and tested for operation in both horizontal and vertical directions and in between i.e., in any position from 0 degrees to 90 degrees.

It is particularly surprising for the man skilled in the art, that one may design a functional motor despite the unusually large air gap with the reluctance principle.

The electric motor according to the instant invention is particularly suitable for the use in pumps, in particular the pumps used to transport aggressive media, such as salt water, chemical solutions in sanitizable or sterilizable pumps, canned pumps (medium transport in the axial direction) etc.

Another application of the said electric motor is in linear motion device. The issue of positioning an element movable in linear direction arises in various types of industrial equipment applications, specially in systems handling dangerous and explosive substances for which various ways have been suggested to solve it [11].

The electric motor of the instant invention is designed and constructed with hollow shaft. By attaching a latch mechanism to the motor the objective of linear motion could be achieved. The lead screw would pass through the hollow shaft and the latch mechanism would convert the rotary motion of motor into linear movement of lead screw. The large air gap between rotor and stator can be used to create a pressure, chemical or environmental seal or boundary.

### DESCRIPTION OF DESIGN

After initial analytical calculations the motor design and simulation was done on the finite element software, Flux-2D, i.e., virtual prototyping [12, 13]. Every conceivable motor parameter was varied to find the most optimum solution. These parameters included:

a) Reluctance Rotor Shapes
Tapered type [14]
Flux barrier type [14, 15]
Heterogeneous type [14, 16]
Notch type [14, 15, 10]
   Square
   Round

b) Motor Geometry
Rotor slot size/shape
Stator slot size
Axial length
Motor housing and stator size
Rotor end ring size

c) Materials
Rotor bar material
   Aluminum bars
   Copper bars
   Silver bars
Stator and rotor core material
   Six different NGO silicon stamping materials
   Flux saturation behavior

d) Electrical Parameters
Number of conductors per stator slot
Voltage
Frequency

e) Number of Poles
2 pole
4 pole
8 pole

### BRIEF DESCRIPTION OF DRAWINGS

FIG. 1: Overall design and geometry of synchronous reluctance motor for conducting media.

FIG. 2: Design and slot sizes of stator for 8-mm air gap motor; for the 9-mm air gap motor the stator teeth were chipped off 1 mm by applying a tool.

FIG. 3: Design and slot sizes of rotor with skewed tapered squirrel cage

FIG. 4: Equiflux lines of the motor

FIG. 5: Performance of motor as angular velocity as a function of time and position.

FIG. 6: Magnetic torque curves

FIG. 7: Hardware block design

FIG. 8: Assembly of prototype motor

FIG. 9: Cross section of prototype motor assembly

FIG. 10: Application of prototype motor as linear motion device shown in latched and de-latched position.

After extensive calculations, analyses and simulations, the design evolved in the form of tapered synchronous reluctance motor meeting all design objectives i.e., stable behavior, least current and maximum torque. Main parameters of the operational design are provided in Table 1.

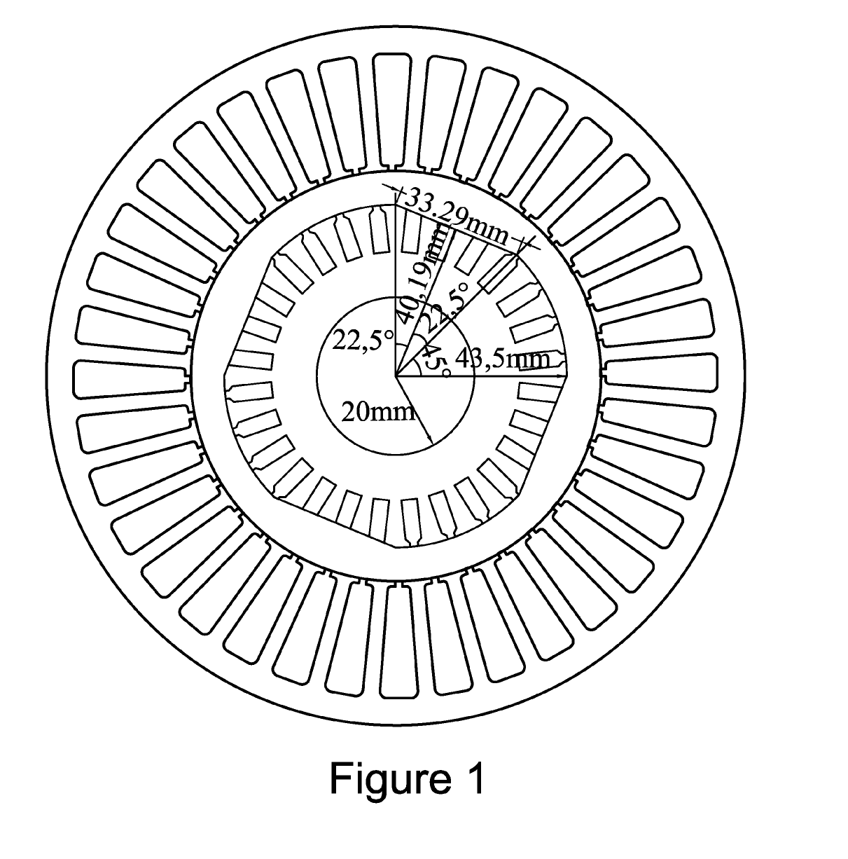

FIG. 1

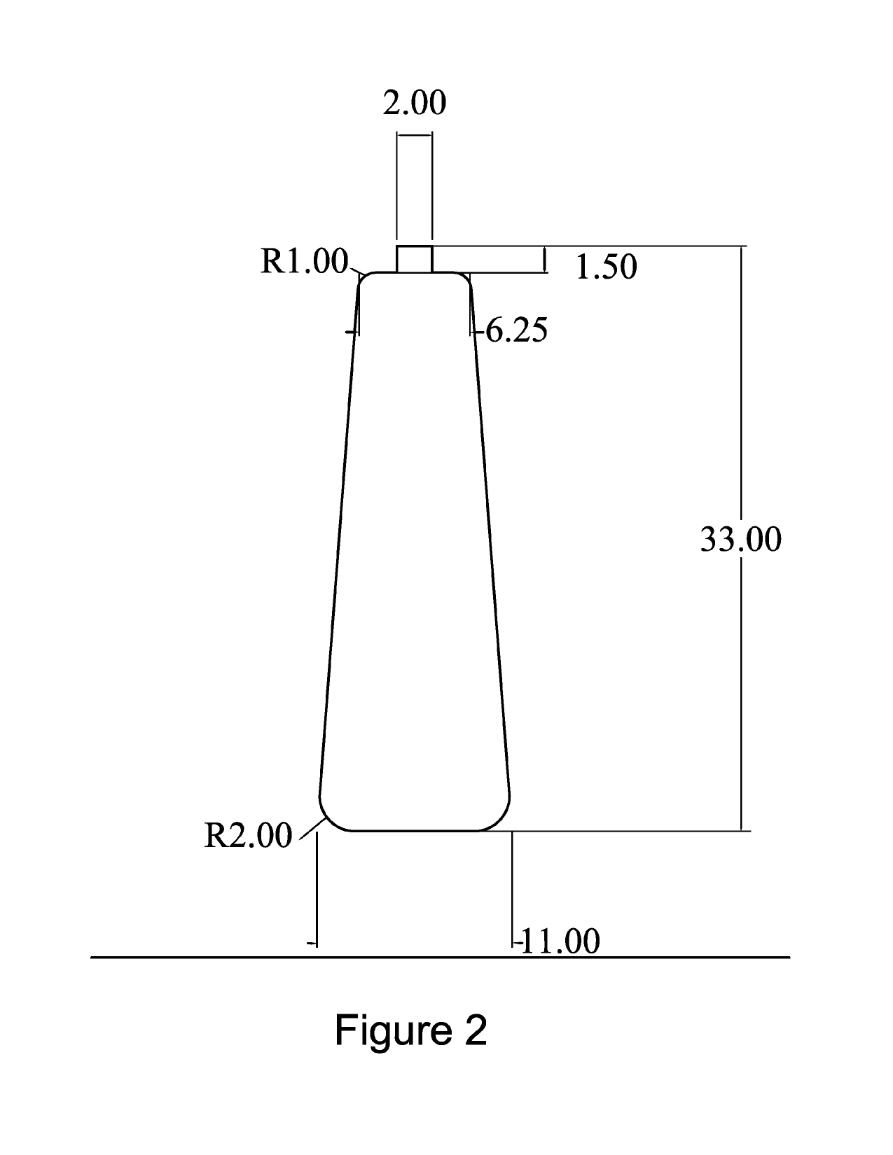

FIG. 2

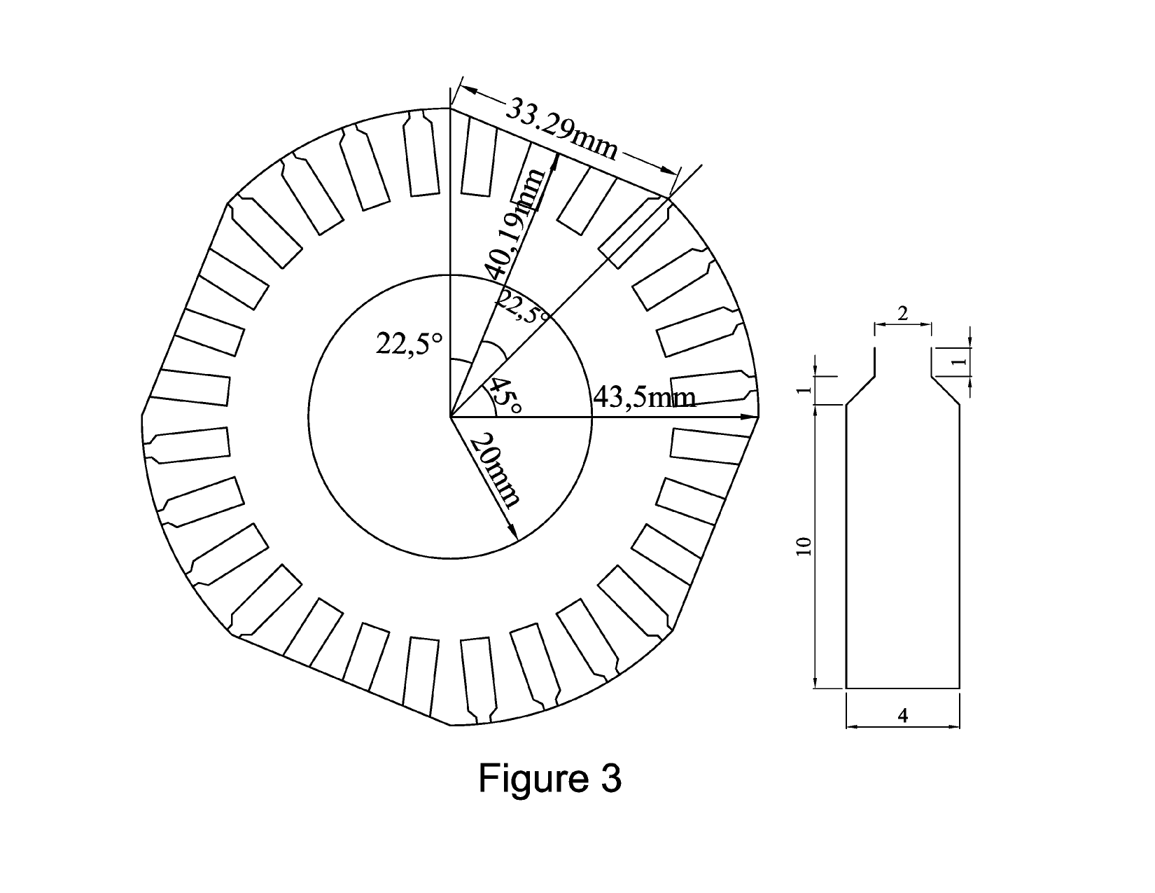

FIG. 3

TABLE 1
Parameters of the design of motor.
a) General

| | |
|---|---|
| Type: | Vertical tapered synchronous reluctance motor |
| Input voltage: | 3-Phase, 220 VAC, 50 Hz |
| Motor geometry | As per FIG. 1 |
| Air gap: | 9 mm |
| Bearing | |
| Upper | Single row deep groove ball bearing, 6208 |
| | stainless steel |
| Lower | Thrust ball bearing (Single row deep groove |
| | ball bearing), |
| Material | 6208 Stainless Steel (SS) |

b) Stator

| | |
|---|---|
| Outer diameter: | 190 mm without housing |
| Internal diameter: | 105 mm |
| Axial length: | 140 mm (stampings) |
| Number of slots: | 36 |
| Slot size: | 6.25 × 11 × 33 mm (FIG. 2) |
| | This size is for 8-mm air gap motor. For the |
| | 9-mm air gap motor the stator teeth were chipped |
| | off 1 mm by applying a tool. |
| Core material: | A 60066-50 (Laminations) |

c) Stator Winding

| | |
|---|---|
| Type: | Double layer, short pitched windings |
| Conductor size: | SWG-20 (0.6567 mm²) |
| Conductor material | Copper |
| Conductor | C class insulation, (200° C. maximum temperature) |
| insulation: | F class Insulating varnish, SOO601 (KRYLON) |
| Other materials: | Wrapping paper (H class) |
| | Glass tape (H-class) |
| | Wood sticks |
| Resistance/phase: | 18.4 Ohms (approx.) |
| Inductance/phase: | 200 mH (approx.) |
| Coil connections: | Standard |

d) Rotor (FIG. 3)

| | |
|---|---|
| Type: | Skew tapered squirrel cage |
| Rotor diameter: | 87 mm |
| Hollow shaft outer | 40 mm |
| diameter | |
| Hollow shaft inner | 30 mm |
| diameter | |
| Rotor core length: | 140 mm without end rings |
| Number of rotor | 28 (Copper) |
| bars: | |
| Rotor bar size | 4 × 12 mm |
| Core material: | A 60066-50 (Laminations) |

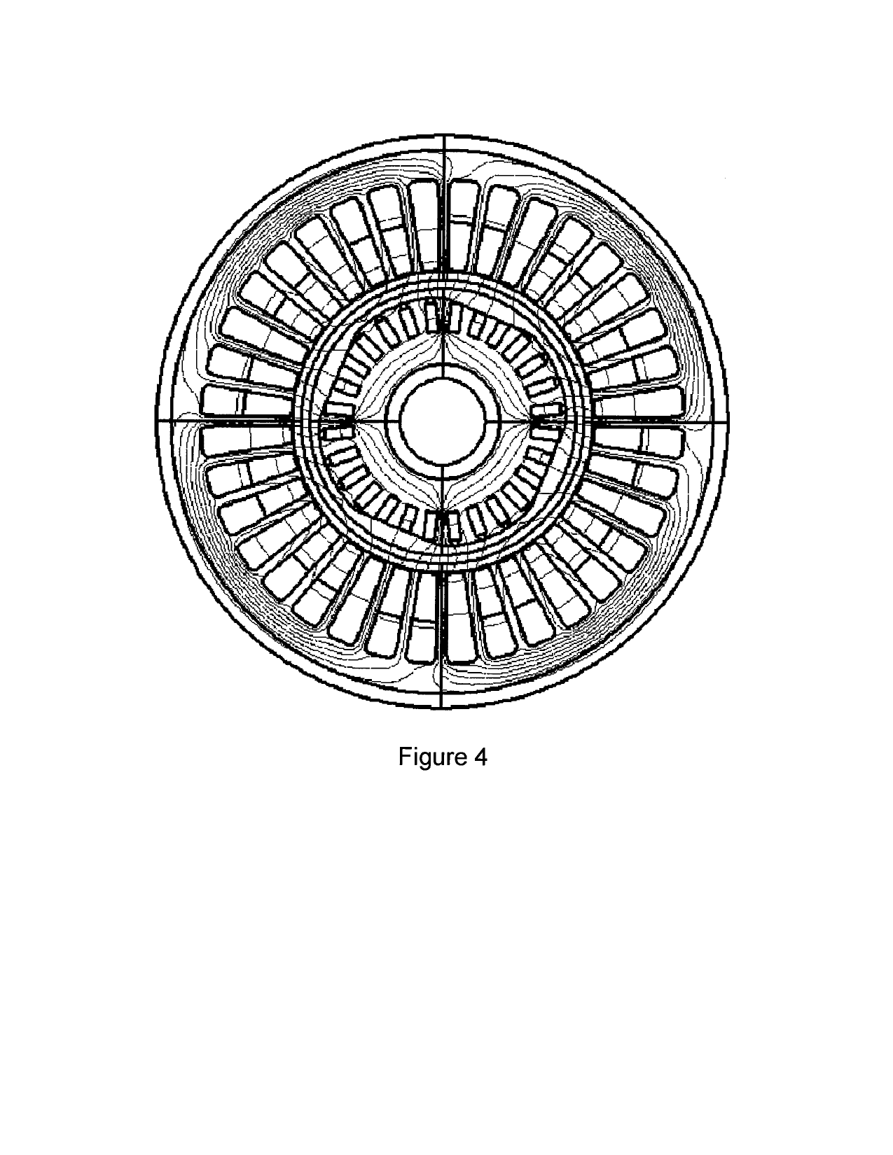

FIG. 4

FIG. 4 shows the equiflux lines results for the 9-mm air gap motor. Between two equiflux lines flows the same quantity of flux. The flux density will therefore be as large as the lines are close to each other. Moreover, the equiflux lines indicate the magnetic field direction, which is tangent to lines at all points.

The motor controller is designed on the basis of open loop terminal volts/Hertz (V/f) control principle [17]. The V/f curves based on this principle are developed with the help of simulations on Flux-2D software. The simulated performance parameters of the prototype of the 9-mm prototype are shown in Table 2.

TABLE 2
Simulated performance of the 9-mm prototype motor

| Frequency | Speed | Voltage | Current | Torque |
|---|---|---|---|---|
| (Hz) | (rpm) | (V, rms) | (A, rms) | (Nm) |
| 0.333 | 10 | 114 | 3.5 | 1.4 |
| 0.666 | 20 | 118 | 3.6 | 1.6 |
| 2 | 60 | 132 | 3.9 | 1.8 |
| 4 | 120 | 154 | 3.9 | 1.8 |
| 8 | 240 | 200 | 3.6 | 1.4 |

The frequency and speed relationship in Table 1 is governed by the equation:

$${n}_{s} = \frac{120 f}{p} \qquad [ 16 ]$$

nₛ=Synchronous speed in rpm
f=Electrical frequency in Hz
p=Number of poles

As the design motor is a 4-pole motor, therefore to rotate it on 10 rpm, 0.333 Hz frequency is required; the same is true for other values. Therefore in this manner, the motor could be operated precisely at any speed value in the low speed range.

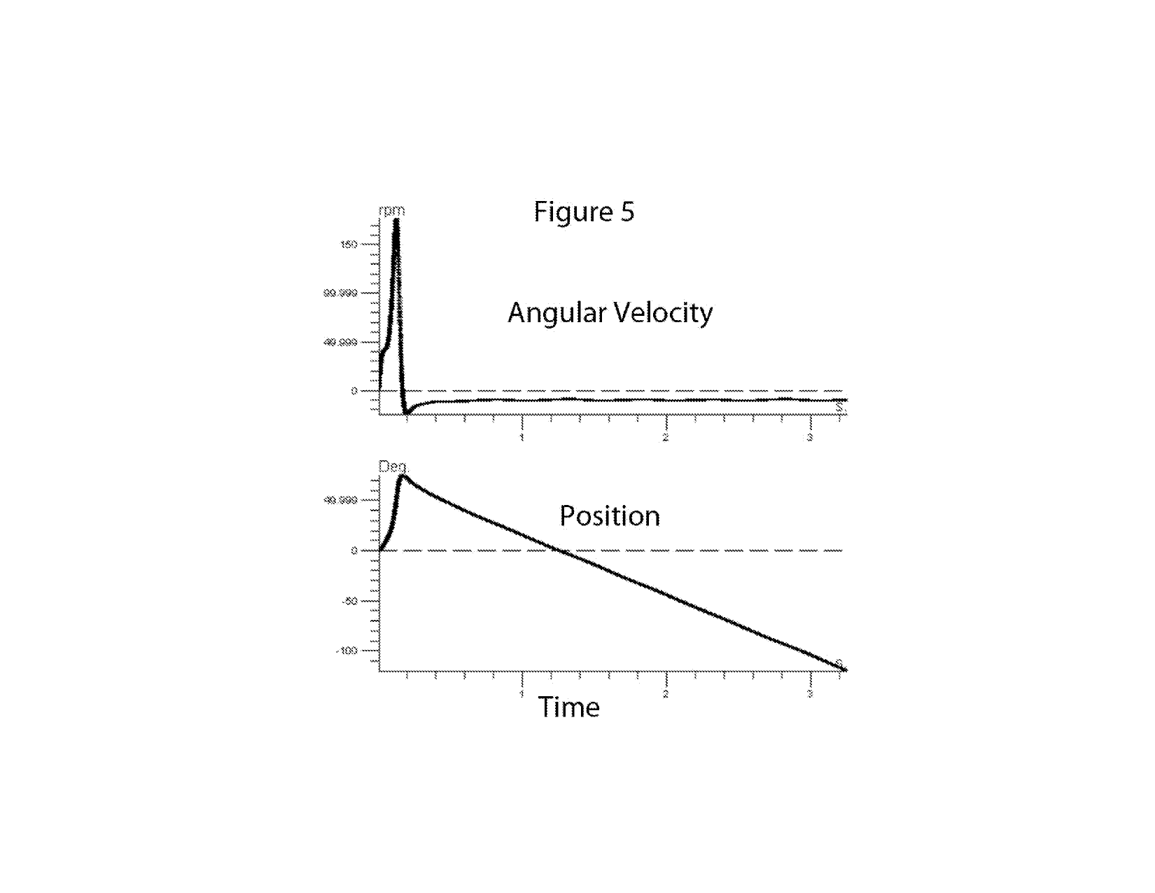

FIG. 5

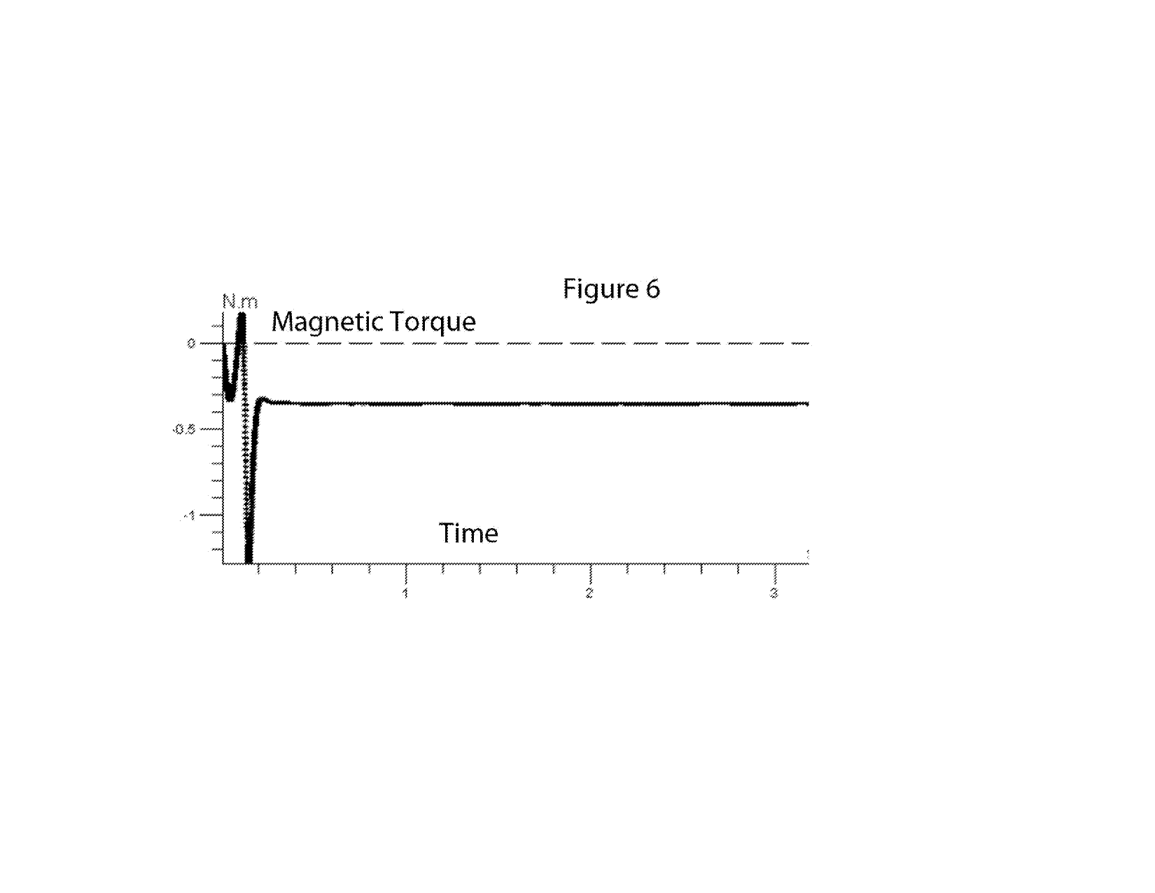

FIG. 6

FIG. 5 shows the angular velocity and position curves for the 9-mm air gap motors. These curves are for 10-rpm simulation. FIG. 6 shows the magnetic torque curves for the 9-mm air gap motors. As the quarter portion of the motor is simulated due to symmetry; the exact torque of motor is four times the torque value listed.

To verify the performance of motor in all respects, a motor load tester was developed. This verification included the measurement of motor parameters e.g. torque, current, voltage, speed etc., in any position from 0° to 90°.

Motor load tester consists of a hysteresis brake mounted on the test bench with the shaft of the motor under test connected with this brake. Hysteresis brake consists of two basic components: a reticulated pole structure and a steel rotor/shaft assembly. When a magnetizing force from a field coil is applied to the pole structure, the air gap between pole and rotor becomes a field. The rotor is magnetically restrained, providing a braking action between the pole structure and rotor.

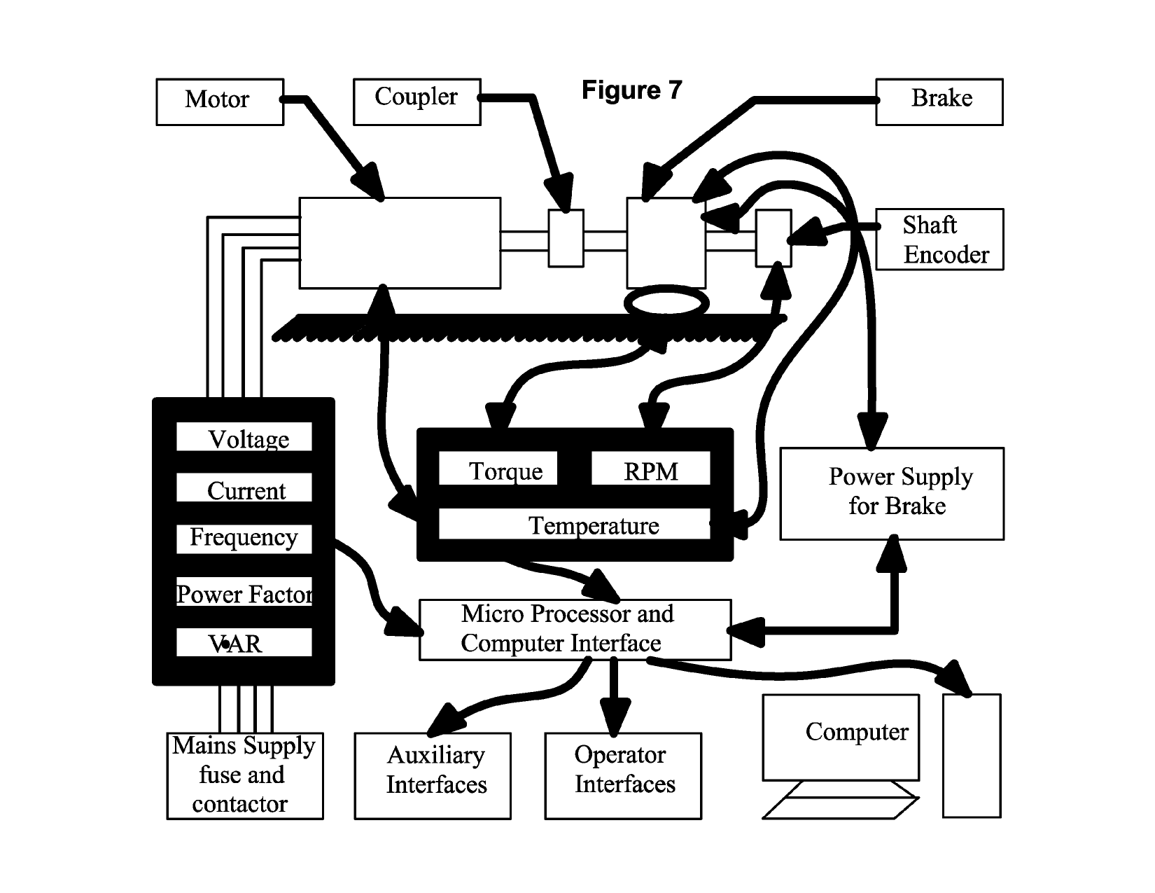

Torque measurement is done through a load cell connected to the free rotor of the brake. Speed of the motor under test is measured with the help of a shaft encoder. Voltage and current measurements are taken with the help of transducers. All these measured parameters and the parameters calculated from them are displayed on the computer. A hardware block diagram is shown in FIG. 7. The test results of the 9-mm motor are shown in the Table 3.

FIG. 7

TABLE 3
Test results of 9-mm motor.

| Direction | | | | | Active | App. | Reac. | | |
|---|---|---|---|---|---|---|---|---|---|
| of | Frequency | Speed | Voltage | Current | Power | Power | Power | Torque | Power |
| Rotation | (Hz) | (rpm) | (V) | (A) | (kW) | (kVar) | (kVA) | (Nm) | Factor |
| CW | 0.333 | 10 | 127 | 3.5 | 1.33 | 1.33 | 0.19 | No Load | 0.99 |
| (30° C.-70° C.) | 0.333 | 10 | 127 | 3.3 | 1.26 | 1.28 | 0.18 | 1.3 | 0.99 |
| | 0.666 | 20 | 113 | 3.2 | 1.09 | 1.1 | 0.16 | No Load | 0.99 |
| | 0.666 | 20 | 113 | 3.1 | 1.04 | 1.05 | 0.15 | 1.2 | 0.99 |
| | 2 | 60 | 117 | 4 | 1.38 | 1.41 | 0.28 | No Load | 0.98 |
| | 2 | 60 | 119 | 3.7 | 1.3 | 1.32 | 0.2 | 1.8 | 0.99 |
| | 4 | 120 | 129 | 3.7 | 1.26 | 1.39 | 0.54 | No Load | 0.92 |
| | 4 | 120 | 128 | 3.6 | 1.7 | 1.32 | 0.49 | 1.4 | 0.93 |
| | 8 | 239 | 166 | 3.6 | 1.41 | 1.66 | 0.87 | No Load | 0.85 |
| | 8 | 239 | 166 | 3.5 | 1.41 | 1.63 | 0.78 | 0.8 | 0.85 |
| CCW | 0.333 | 10 | 129 | 3.3 | 1.29 | 1.3 | 0.18 | No Load | 0.99 |
| (70° C.-110° C.) | 0.333 | 10 | 130 | 3.2 | 1.27 | 1.29 | 0.18 | −1.3 | 0.99 |
| | 0.666 | 20 | 138 | 3.4 | 1.44 | 1.48 | 0.21 | No Load | 0.99 |
| | 0.666 | 20 | 139 | 3.3 | 1.41 | 1.43 | 0.2 | −1.3 | 0.99 |
| | 2 | 60 | 161 | 3.8 | 1.86 | 1.92 | 0.46 | No Load | 0.97 |
| | 2 | 60 | 161 | 3.7 | 1.78 | 1.83 | 0.45 | −1.5 | 0.97 |
| | 4 | 120 | 164 | 3.8 | 1.73 | 1.99 | 0.93 | No Load | 0.88 |
| | 4 | 120 | 164 | 3.7 | 1.69 | 1.92 | 0.91 | −1.5 | 0.88 |
| | 8 | 239 | 176 | 3 | 1.66 | 1.74 | 0.6 | No Load | 0.93 |
| | 8 | 239 | 177 | 3 | 1.64 | 1.74 | 0.87 | −0.7 | 0.9 |

### EXAMPLES

### Media Transport

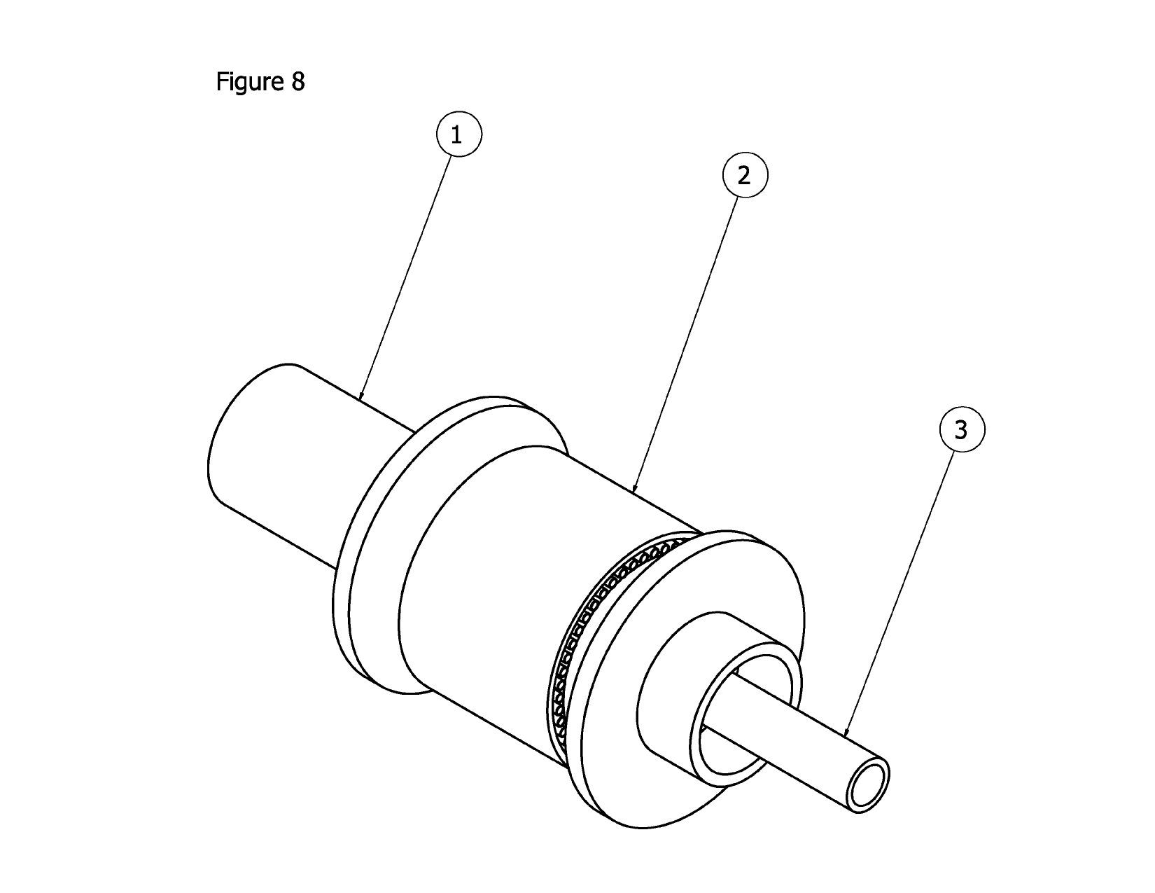

FIG. 8

FIG. 8 shows the use of said motor for conducting media. In this embodiment, the cylinder (1) is placed between rotor (3) and stator (2). This cylinder acts as chemical, pressure or environmental seal. The thickness of the cylinder depends on the nature of application. If the purpose were to only provide chemical or environmental seal/boundary then the thickness of the cylinder would be minimum. If the purpose of the cylinder were to serve as pressure boundary then the thickness of the cylinder would be higher according to the requirement. Similarly, the rotor can also be canned when dealing with hazardous media. This topology results in total elimination of any fluidic seals or dedicated magnetic couplings; as the above mentioned cylinder would act as external boundary or seal and no seal would be required on rotating part i.e., shaft.

The above-mentioned topology makes it an ideal solution for use in the pumps, in particular in pumps for aggressive media, such as salt water, chemical solutions; in disinfectable or sterilisable pumps, canned pumps (medium transport in the axial direction) etc.

### Linear Motion Device

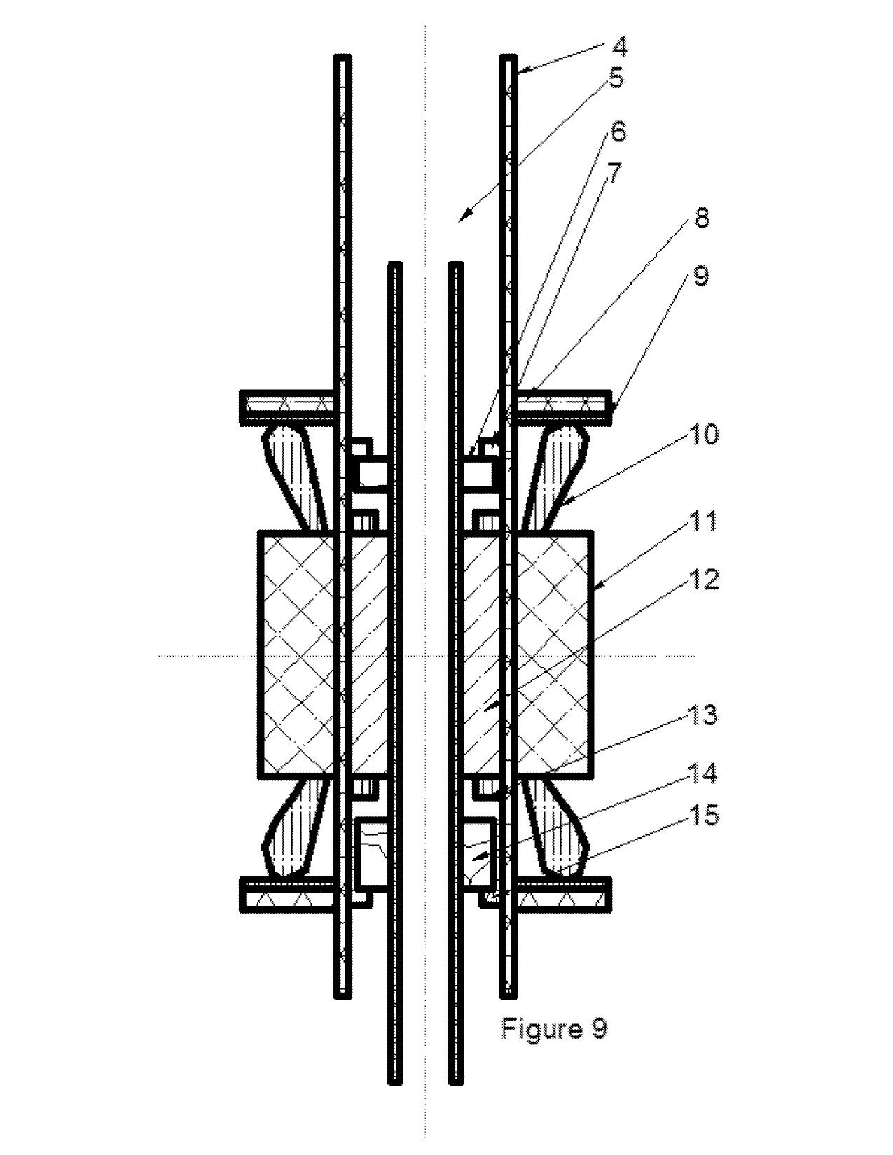

FIG. 9

Another application of the invented motor is its use in linear motion device. FIG. 9 explains in detail this concept. There is a cylinder (4) between rotor (12) and stator (11) to form a pressure, chemical or environmental seal. The element to be moved linearly travels through the hollow shaft. The present figure represents the case when the motor is fixed vertically. This is equally applicable when the motor is fixed horizontally. Other components of said device include hollow rotor shaft (5) upper bearing (6), rotor end plate (7), stator end plate (8), oil impregnated sheet (9), stator end winding (10), rotor end ring (13), lower bearing, 6208 (14), rotor end plate (15).

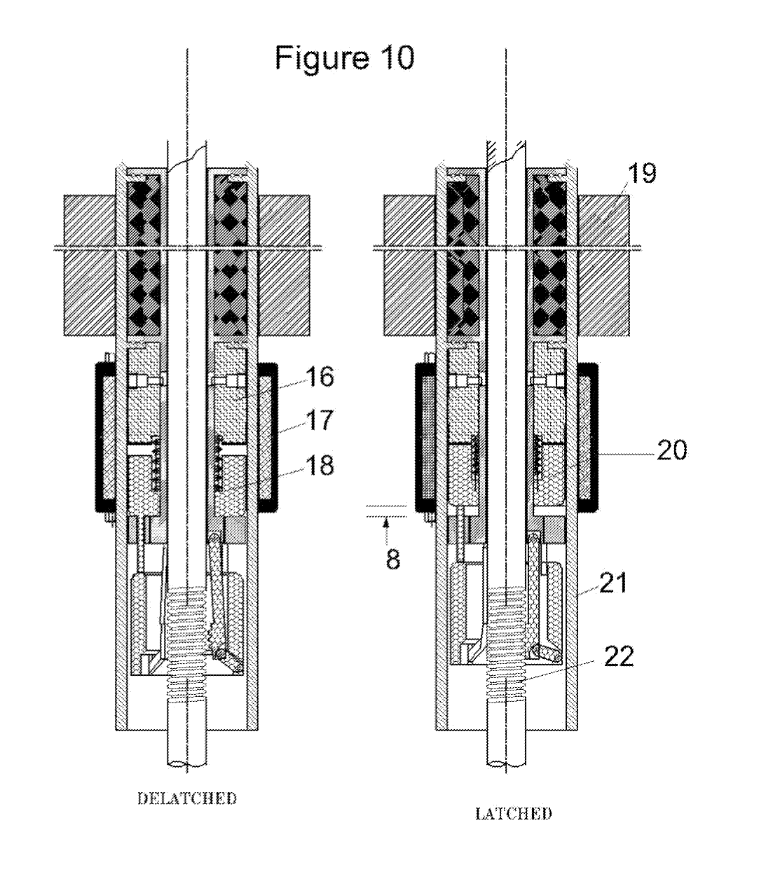

FIG. 10

FIG. 10 depicts this embodiment in detail. Below the motor (19), there is latch mechanism (20). The latch mechanism consists of a control element (22) comprising electrical coil, magnetic pole and armature. When the electrical coil (17) is energized the pole becomes magnetized and pulls the armature upwards. Thus armature is connected with the element to be moved linearly. The motor rotates radially and so pole (16) and armature (18) allowing movement within the environmental, chemical or pressure seal or boundary (21). This radial motion of armature is converted into linear movement of control element through latch mechanism. FIG. 10 shows both the latched and de-latched conditions.

### REFERENCES

[1] Godeke et al., “electric motor”, United States Patent Office, 20080292480 A1 (27 Nov. 2008).
[2] J. Chandler, “PMSM technology in high performance variable speed applications”, Automation Inc., an Infranor Inter AG Company, www.servo-motors-controls.com
[3] A. Binder, H. Schima and H. Schmallegger, “Motor design with large air gap for centrifugal blood pumps using rare-earth magnets”. Electrical Engineering (Archiv fur Elektrotechnik), Volume 73, ISBN 0948-7921 (Print) 1432-0487 (Online) Number 4, pp 261-269 (July 1990)
[4] J M Meswania, S J G Taylor, and G W Blunn, “Design and characterization of a novel permanent magnet synchronous motor used in a growing prosthesis for young patients with bone cancer”, Proc. IMechE Vol. 222 Part H: J. Engineering in Medicine, pp 393-401 (October 2007)
[5] R. K. Agarwal, “Principles of electrical machine design” S. K Katrina and Sons, New Delhi, 313-314 & 377 (1997).
[6] J. Chandler, “PMSM technology in high performance variable speed applications”, Automation Inc., an Infranor Inter AG Company, www.servo-motors-controls.com
[7] J. Haataja, “A comparative performance study of four-pole induction motors and synchronous reluctance motors in variable speed drives”, PhD thesis, Lappeenranta University of Technology, Finland, 23 (2003).
[8] JR. Hendershot Jr., TJE Miller, DA Staton, R. Lagerquist, “The synchronous reluctance motor for motion control applications”, www.jimhendershot.com
[9] R. R. Moghaddam, “Synchronous reluctance machine (SynRM) design”, MS thesis, KTH University, Sweden, 75-76 (2007).
[10] M. S. Sharma, M. K. Pathak, “electric machines”, Cengage Learning (2009)
[11] W. C. Roman, R. C. Robinson, “Linear motion device”, United States Patent Office, 2,780,740 (1957).
[12] J. K. Sykulski, “New trends in optimization in electromagnetics”, Przegl [symbol] d Elektrotechniczny 83 (6), 13-18 (2007).
[13] J. K. Sykulski, “Computational electromagnetics for design optimisation: the state of the art and conjectures for the future”, Bulletin of the Polish academy of sciences 57(2), (2009).
[14] C. I. Hubert, “electric machines: Theory, operation, applications, adjustment and control”, Prentice Hall Inc. USA, (1991).
[15]. Boldea, “Reluctance synchronous machines and drives”, Clarendon Press, Oxford, (1996).
[16] S. J. Chapman, “electric machinery fundamentals”, McGraw-Hill International edition, (1991).
[17] J. M. D Murphy, F. G Turnbull, “Power electronic control of AC motors”, Pergamon Press (1988)

What is claimed is:

1. A synchronous reluctance electric motor with air gap comprising
a stator which produces a rotating magnetic field by applying a current to a winding;
a cylindrical housing inserted inside said stator wherein an outer peripheral surface of said cylindrical housing is supported by stator;
a tapered reluctance rotor without permanent magnets formed in a roughly cylindrical shape with a hollow shaft placed at an inner peripheral surface of said cylindrical housing and rotated in synchronism with the rotating magnetic field of said stator;

2. The electric motor of claim 1 wherein said air gap between said rotor and said stator is 9 mm.

3. The electric motor of claim 1 wherein said motor is operated at low speed.

4. The electric motor of claim 1, wherein the speed of said motor is controlled by a scalar V/f control.

5. The electric motor of claim 1, wherein said motor is used to convey fluid media, both corrosive and non-corrosive without using any magnetic coupling or fluidic seals.

6. The electric motor of claim 1, wherein said motor is used to produce a linear motion.
